(19) United States
(12) Patent Application Publication
(10) Pub. No.: US 2026/0359395 A1
(43) Pub. Date: Nov. 12, 2026

(54) SYSTEMS AND METHODS FOR AI EVALUATION OF MODELS

(71) Applicant: Blue Boat Data Inc., New York, NY (US)

(72) Inventors: Moein Owhadi Kareshk, Burnaby (CA); Hamed Ahmadi, Burnaby (CA); Parinaz Vahabzadeh, New York, NY (US)

(73) Assignee: Blue Boat Data Inc., New York, NY (US)

(21) Appl. No.: 19/668,871

(22) Filed: May 6, 2026

Related U.S. Application Data
(60) Provisional application No. 63/801,488, filed on May 7, 2025.

(51) Int. Cl. G06F 18/213

(52) U.S. Cl. CPC G06F 18/213

(57) ABSTRACT

A system for evaluating a candidate tool comprises at least one processor operatively connected to a memory. The processor accepts specification of a target task the candidate tool performs, data types and data fields including ranges, and hidden patterns to include in synthetic data. The processor generates a step-by-step plan for making synthetic data and produces synthetic data with text descriptions explaining hidden patterns integrated therein. The processor provides an interface to provide synthetic data to the candidate tool and capture a text description generated by the candidate tool including patterns found in the synthetic data. The processor evaluates the text description and patterns found by the candidate tool against details specified in a ground-truth definition used to produce the synthetic data and permits subsequent use of the candidate tool based on the evaluation.

### RELATED APPLICATIONS

This application is a non-provisional which claims priority under 35 U.S.C. § 119(e) to U.S. Provisional Application Ser. No. 63/801,488, filed May 7, 2025, entitled “SYSTEMS AND METHOD FOR AI EVALUATION OF MODELS”, which is herein incorporated by reference in its entirety.

### BACKGROUND

Many approaches exist for validation, verification, and benchmarking of machine learning models or any modeling, regressions, approximation, data discovery tool, etc. These approaches attempt to provide insight on training data issues, modeling parameter issues, fitting issues, architecture issues, among other options. However, many existing solutions rely on blunt subjective comparisons, for example, of free-form narratives (as two texts), among other approaches, and thus fail to provide sufficient insight as to actual cause.

### SUMMARY

The result of these conventional approaches is that existing solutions only provide an approximation of a tool's performance with little or no insight on how and why a tool is unsuited, inaccurate, or poorly architected. These issues are even more pronounced in existing data discovery and data mining tools. The inventors have realized that there is a need for objective measures that can be applied across any model to assess performance, recall, precision, f1-score, or any customized metric, among other options. According to one aspect, a system for objective evaluation of a candidate model is provided. The system is configured to build synthetic data having customizable and testable patterns. When the system generates synthetic data, the system is configured to generate the data and a textual description of it. According to some embodiments, atomic probing, profiling, & diagnostic assertions (APPDAs) are extracted from the description of the data. In further embodiments, by scoring each APPDA individually (e.g., using—true positive (TP), false positive (FP), and false negative (FN) determination, among other options), the system and underlying framework exposes where and why a tool succeeds or fails. This functionality is unavailable in conventional solutions and improves over existing systems.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is an example of process flow and system elements of an example system, according to one embodiment;

FIG. 2 is a diagram of an example evaluation, according to one embodiment; and

FIG. 3 is a block diagram of an example special purpose computer system improved by the functions and/or processes disclosed herein.

FIG. 4 is a diagram illustrating an APPDA structure and generation process, according to one embodiment;

FIG. 5 is a diagram illustrating synthetic data generation approaches, according to one embodiment;

FIG. 6 is a diagram illustrating task specification parameters, according to one embodiment;

FIG. 7 is a diagram illustrating an examination matching process, according to one embodiment;

FIG. 8 is a diagram illustrating a parallel execution architecture for scalable benchmarking, according to one embodiment;

FIG. 9 is a diagram illustrating evaluation report output formats, according to one embodiment; and

FIG. 10 is a flowchart illustrating a code modification mechanism, according to one embodiment.

### DETAILED DESCRIPTION

Various embodiments of the system provide a framework to evaluate, validate, and benchmark a knowledge discovery and data mining tool by generating tailored synthetic data and its description and systematically comparing the tool's output to the data description ground truth. In further embodiments, the system is configured for deterministic operation. According to one embodiment, the system generates questions in a plurality of APPDAs, and for a given question in a APPDA, the system compares the following two elements: (1) the answer(s) extracted from the tool's output and (2) the ground truth answer(s) provided by the APPDA.

In a further example, the system can begin with optional task specifications that detail the target tasks, data types, fields, value ranges, and hidden patterns, which can be summarized and planned for by a scenario planner into a comprehensive, step-by-step plan for synthetic data generation. Guided by this plan, a data generator produces synthetic data along with a textual ground-truth data description. The system is configured to embed and plant hidden patterns in the synthetic data and describe those patterns in the data description. If the user of this system does not provide the optional Task Specifications, the scenario planner can generate task specifications for an arbitrary scenario.

According to one embodiment, this synthetic data is analyzed by the black-box data mining tool, which outputs its own description of discovered patterns as a textual output. The black-box data mining tool is itself an input to the system that provides the framework to evaluate, validate, and benchmark any knowledge discovery and data mining tool. To objectively assess the tool's performance in a robust way, the system is configured to operate according to a new paradigm—encompassed by the novel concepts of atomic probing, profiling, and diagnostic assertions (APPDAs) that are tailored to individually evaluate specific atomic aspects (pieces of information) of the ground truth. An examiner module is configured to evaluate the correctness and completeness of a candidate tool's output by computing true positives, false positives, and false negatives for each APPDAs. These quantities are calculated by comparing the tool's responses with the ground truth for each assertion. In some examples, each ground-truth question (assertion) can have multiple correct answers, which can be similar or semantically distinct.

This process of generating synthetic data and APPDAs and evaluating the APPDAs can be done for a specific number of times or until any preferred termination condition is met. Finally, an analyzer calculates evaluation metrics (including such as the Jaccard Similarity Index, Precision, Recall, and F1 Score) and produces the final evaluation report. The evaluation reports of different knowledge discovery and data mining tools can be compared and contrasted to rank them or choose the most suitable option based on the specific requirements of the tasks.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element, or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

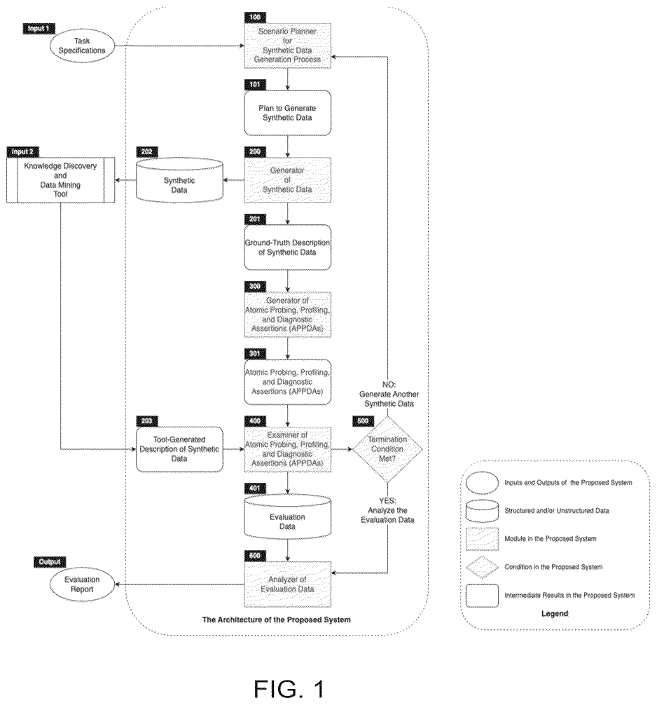

FIG. 1 illustrates example flow and elements of an evaluation system. According to some embodiments, the system can be configured to evaluate, validate, and/or benchmark a given model (e.g., large language model “LLM,” artificial neural network, etc.) knowledge Discovery and Data Mining Tool (Input 2) by generating tailored synthetic data. The main modules of the system can rely on LLMs invocation to process their input(s) and generate their output(s). The modules might use any other sequence generation software or tool, instead of LLMs. Each module is optionally configured to pre-process its output before invocation of an LLM and optional configured to post-process the output of the LLM to generate the output of the module. The system initiates by ingesting Task Specifications (Input 1) that define the task, data fields, types, numerical ranges, and hidden patterns to embed. These specifications are summarized by Scenario Planner for Synthetic Data Generation Process (100), which devises a comprehensive, step-by-step plan for synthetic data generation, including necessary tools and process guidelines (Plan to Generate Synthetic Data (101)). Guided by this plan, Generator of Synthetic Data (200) produces Synthetic Data (202) along with ground-truth description of synthetic data (201) that explicitly documents the planted patterns. The synthetic data is then analyzed by the Knowledge Discovery and Data Mining Tool (Input 2), which outputs the tool-generated description of synthetic data (203). To assess the fidelity of tool's analysis, a set of atomic probing, profiling, and diagnostic assertions (APPDAs) (301) is generated by the Generator of atomic probing, profiling, and diagnostic assertions (APPDAs) (300), and Examiner of atomic probing, profiling, and diagnostic assertions (APPDAs) (400) systematically compares each atomic assertion between the tool output and the ground-truth, and computes true positives, false positives, and false negatives. These evaluation results are stored in Evaluation Data (401). Termination Condition Met? (500) evaluates whether to repeat the generation-evaluation cycle or finalize the process, thus establishing a closed loop. Finally, the evaluation data is analyzed via the Analyzer of Evaluation Data (600) to calculate metrics such as the Jaccard Similarity Index, Precision, Recall, and F1 Score. Evaluation Report (601) is the output of the system and contains all of the calculated metrics.

According to various embodiments, the system can utilize the following inputs and/or instantiate the following components to execute the described workflow, functionality, steps, and/or algorithms. In other embodiments, the system can be configured to perform the various operations and/or functions with the described inputs/output without instantiation of any specific component. According to one embodiment, the system and/or inputs can include one or more or any combination of the following.
Task Specifications (Input 1): These input specifications introduce and clarify different characteristics of the target synthetic including but not limited to (1) the machine learning task(s) that the data should address (e.g., classification, regression, time series, unstructured, textual, visual, etc.), (2) expected data fields (e.g., dates, specific business metrics, temperature, user comments), (3) data types (e.g., string, integers, boolean, unstructured, textual, visual, etc.), (4) data ranges (ranges for dates, expected numerical ranges for business metrics, etc.), and (5) expected or suggested hidden patterns to plant in the data (trends, seasonalities, outliers, concept drifts, etc.) and their (hyper-)parameters, etc. According to various embodiments, any task specifications is an optional input provided by the user who wishes to evaluate a respective data mining tool. A specification enables the system to focus or customize evaluation on a specific aspect of a tool's functionality according to a user's parameters. The system is configured to allow users to steer and customize the evaluation process accordingly. For example, if a tool is designed solely to detect outliers, it would not make sense to include patterns unrelated to outliers in the data. In another example, embedding a trend pattern, for instance, would result in an irrelevant evaluation, as the tool being evaluated is not intended to detect trends.
Knowledge Discovery and Data Mining Tool (Input 2): This is the knowledge discovery and data mining tool to verify, validate, and/or benchmark. The system is configured for a black-box approach to this input tool where the system does not make any assumption about its internal functionalities or components. Various examples assume that this tool receives structured and/or unstructured data as input. As output, it generates a textual description of patterns, knowledge, and information it discovers or mines from the input data. There is no assumption about the different characteristics of the textual description. This includes but is not limited to, no assumption or constraint about the length, tone, language, and analysis depth of this description. Examples of such tools include but are not limited to LLM-based systems and agentic frameworks.
Scenario Planner for Synthetic Data Generation Process (100): This module creates a plan to generate the synthetic data, which includes (1) the summary of Task Specifications (Input 1), (2) any considerations or pitfalls in the process of data generation, (3) any tool necessary to use in the process of data generation, (4) detailed processes of planting specific patterns in the data, and (5) step-by-step guidelines to approach the data generation process if the process is needed to be multistep. According to some embodiments, the planning and summarization process is performed automatically using AI models, such as LLMs. For example, the system can be configured to provide the Task Specification and prompt to an LLM to generate the planning and summarization. The generation can occur either through a single invocation of the LLM or through an interactive conversation with the user. In fact, various embodiments can be configured to execute any of the described steps herein either via a single LLM (or any other sequence generation tool) or through a conversational interaction. In some examples, patterns are embedded into the data intuitively. For instance, a simple sequence of increasing numbers can represent an upward trend. In other examples, complex patterns can be embedded under a step-by-step program for proper embedding managed by the system. Such complex patterns often introduce multiple elements such as trends, seasonality, and anomalies simultaneously.
Plan to Generate Synthetic Data (101): This is the plan that the Scenario Planner for Synthetic Data Generation Process (100) generates. In various examples, the plan is specified as textual information, and there are no assumptions or constraints on its length, tone, and language. In some embodiments, planning is a textual process. The system augments such textual approaches with the inclusion of task clarification, task summarization, and planning steps before the data generation begins. In various executions, the Task Specification is an optional input, thus if the user does not provide one, the Planner step is configured to autonomously generate a generic scenario.
Generator of Synthetic Data (200): This module is configured to generate synthetic data and a textual description of it. The synthetic data is the input to the Knowledge Discovery and Data Mining Tool (Input 2), and the textual description is the ground truth for the evaluation. According to some embodiment, the data description is automatically generated using AI, such as a large language model (LLM). For example, an LLM can be tasked with both summarization and planning, and then tasked to produce code that generates the synthetic data and corresponding description. The system can be configured to execute the generated code to create the dataset and directly use the generated description. In this example, the code and the data description can also be produced separately through two distinct LLM invocations. In some alternative embodiments, the LLM could bypass code generation entirely and produce the data directly.
ground-truth description of synthetic data (201): This is a textual explanation of the patterns and knowledge that is embedded and planted in the synthetic data and it is used as the ground truth knowledge. The evaluation can be based on the principle that the output of the Knowledge Discovery and Data Mining Tool (Input 2) should be consistent with this description and cover all information in it. The system can then test how well a model is consistent and/or covers all information defined by the ground truth description.
Synthetic Data (202): The Generator of Synthetic Data (200) module can generate synthetic data in multiple ways depending on the task specifications and constraints. The synthetic data can be structured or unstructured and can be compatible with or not compatible with standard data storage and schema tools including not limited to Relational Database Management Systems (RDBMSs), and NoSQL databases. For instance, the generator can directly generate the data via an LLM invocation, or in other examples the module can be configured to write computer code that generates the synthetic data. For more complex scenarios, having the ability to generate and execute code gives enough flexibility to the system to embed and plant sophisticated patterns in the data. When generating code, the system provides a task summary along with the relevant parts of the planning that pertain to data generation and requests to an LLM (or any sequence generation tool) to produce code to output synthetic data having the parameters defined by the textual explanations and any formatting specification. According to one embodiment, the LLM generates the code and the system runs static analysis tools to detect any potential security vulnerabilities or inconsistencies before attempting to execute the code. If the code passes this preliminary check, it is then executed to generate the synthetic data. The system can be configured to compare the high-level characteristics of the generated data such as dataset size, expected fields, and structural alignment with the original planning. If the generated data fails to meet the expectations, a code modification mechanism is triggered. In the code modification mechanism, the LLM is re-invoked and provided with: (1) the previously generated code; and (2) a description of the error or issue encountered. The LLM is then asked to revise the code accordingly. This enhancement loop can be executed until the output data aligns fully with the specified expectations.
tool-generated description of synthetic data (203): The synthetic data is passed to the Knowledge Discovery and Data Mining Tool (Input 2) and the tool generates a textual description of the data, including analysis of it from different perspectives. An example goal of the rest of the modules is to compare this description with the ground-truth description of synthetic data (201) in a robust and meaningful way. Various embodiments are configured to focus on validating, verifying, benchmarking, and evaluating data mining tools. Thus, the system can be tailored to tools that take a dataset as input and produce a textual description of the patterns or knowledge extracted from the data. In further example, the system is also configured to manage tools where the output is in the form of numerical values (such as a single table), based on treating such data as a textual output.
Generator of atomic probing, profiling, and diagnostic assertions (APPDAs) (300): Evaluating the output of Knowledge Discovery and Data Mining Tool (Input 2) by directly comparing the analyses it generates (tool-generated description of synthetic data (203)) with ground-truth description of synthetic data (201) would be a subjective, non-deterministic, and imprecise since these two texts might be different in terms of the depth of analysis, format, tone, language, style of analysis, etc. The system operates according to a novel concept called APPDAs. These are a set of assertion questions that solely question a single atomic aspect of the ground-truth description of synthetic data (201). These questions are atomic and have deterministic, objective, and straight-to-the-point answers (e.g., usually in a few tokens). An APPDA can have multiple valid and correct answers where mentioning each of them in the tool-generated description of synthetic data (203) would be acceptable. The assertions can evaluate the analysis from probing, profiling and diagnostics aspects. APPDAs are automatically generated using any sequence generation tool (among other tools). For example, the system is configured to provide an LLM with a ground-truth data description and prompt the LLM to formulate a question about a single piece of information from the description. The LLM is prompted to generate the top-k potential correct answers for that question. In further example, the system can ask the LLM to generate a type of analysis that it targets for each specific APPDA, such as trends, outliers, etc. Example of an APPDA: Question: In which month in 2024, the revenue inconsistent with the rest? Answers: [April, May, June], [Spring], [The second quarter].
atomic probing, profiling, and diagnostic assertions (APPDAs) (301): This is the list of probing, profiling and diagnostic assertions in the form of questions associated with a set of correct answers.
Examiner of atomic probing, profiling, and diagnostic assertions (APPDAs) (400): This module aims to examine if the tool-Generated Description of Synthetic Data (203) answers the atomic probing, profiling, and diagnostic assertions (APPDAs) (301) correctly. This examination can be done in different ways including string matching, pattern matching, and LLM invocation. The latter reduces the risk of missing answers in more sophisticated analysis or when the tone and language of the tool- Generated Description of Synthetic Data (203) and APPDAa are different. In this approach, the LLM is given the tool-generated description of synthetic data (203) and a single APPDA (a question without the correct answer(s)) and it must answer the question only using the tool-generated description of synthetic data (203) and no other common knowledge or background information. The LLM can generate more than a single answer as multiple answers, while distinct, can be correct. Then, for that specific question, the set of answers from that specific APPDA (Set A) and the set of generated answers (Set B) are compared. In this comparison, the answers from the two sets are matched and three quantities True Positive (TP), False Positive (FP), and False Negative (FN) are calculated for the APPDA in hand. These quantities are stored in Evaluation Data (401), which is the database of all examination results. Here are the detailed descriptions of these quantities: True Positive (TP): These are the number of answers that exist in both Set A and Set B. False Positive (FP): These are the number of answers in Set B that do not exist in Set A. False Negative (FN): These are the number of answers in Set A that do not exist in Set B.

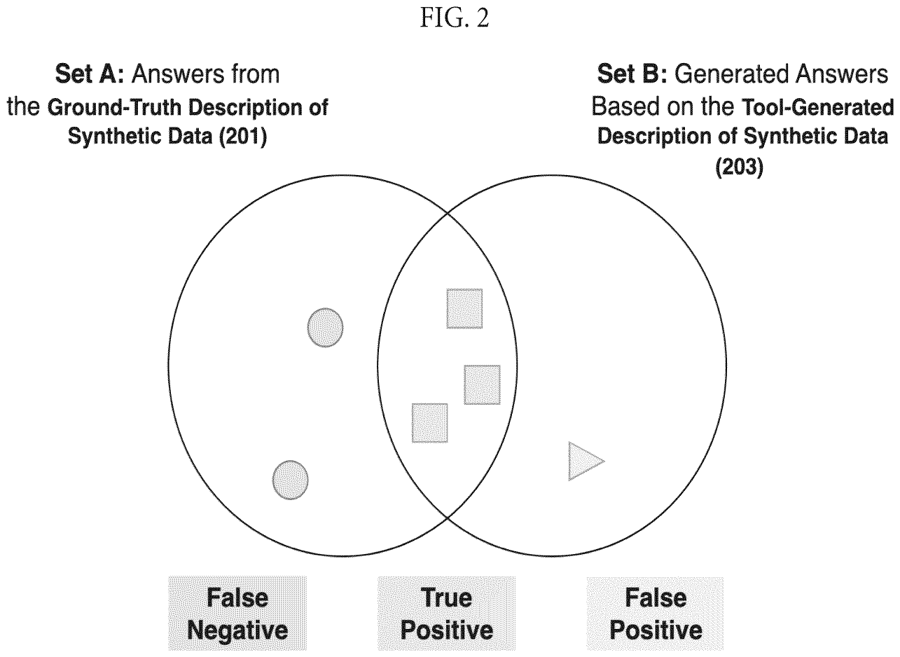

FIG. 2 is an example diagram of an output evaluation. In FIG. 2, the TP (in green) is three (3), the FP (in pink) is one (1), and FN (in red) is two (2). Various embodiments are configured to validate, verify, and/or benchmark performance of a candidate tool/model based on TP, FP and FN quantities.

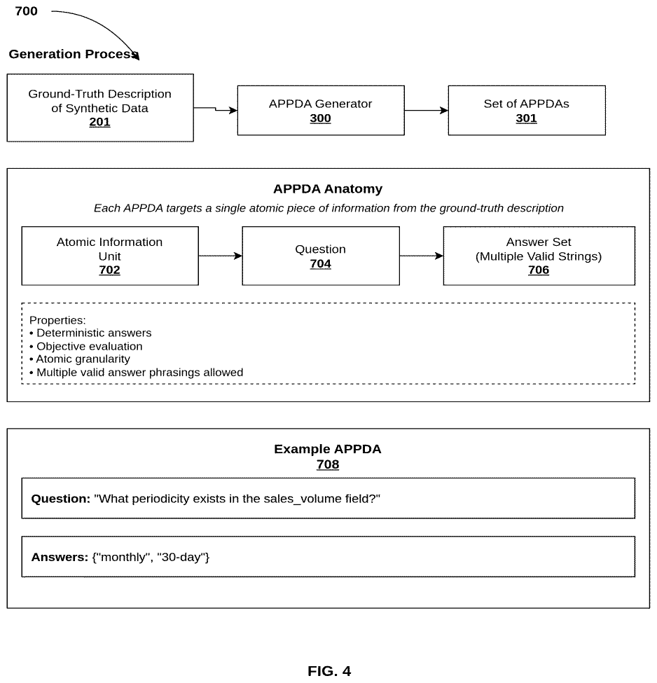

FIG. 4 illustrates the APPDA structure and generation process (700). According to some embodiments, the generation process begins with ground-truth description of synthetic data (201), which is provided to generator assertions (300). The generator assertions (300) produces a set of APPDAs (301). According to one embodiment, each APPDA targets a single atomic information unit (702) from the ground-truth description. The atomic information unit (702) is transformed into a question component (704), which is associated with an answer set (706) containing multiple valid strings. According to various embodiments, APPDAs have the following properties: deterministic answers, objective evaluation, atomic granularity, and multiple valid answer phrasings allowed. According to one example, an example APPDA (708) is shown with the question “What periodicity exists in the sales_volume field?” and the answer set {“monthly”, “30-day” }, demonstrating how multiple valid phrasings can correctly answer a single atomic assertion.

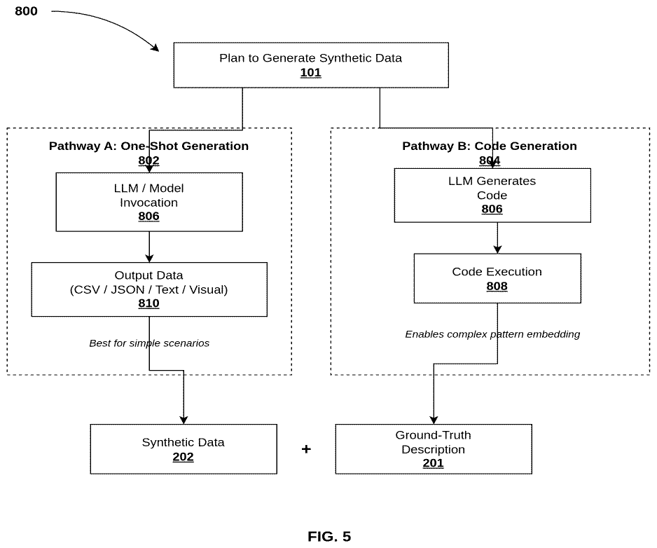

FIG. 5 illustrates synthetic data generation approaches (800). According to some embodiments, the generation process begins with a plan (101) to generate synthetic data. The plan diverges into two alternative pathways. According to one embodiment, pathway A represents a one-shot generation pathway (802), in which an LLM invocation (806) directly produces output data (810) in formats such as CSV, JSON, text, or visual data. According to another embodiment, pathway B represents a code generation pathway (804), in which an LLM invocation (806) generates executable code, followed by code execution (808) to produce the output. According to one example, the one-shot generation pathway (802) is best for simple scenarios, while the code generation pathway (804) enables complex pattern embedding. According to various embodiments, both pathways produce synthetic data (202) and ground-truth description of synthetic data (201) documenting the planted patterns.

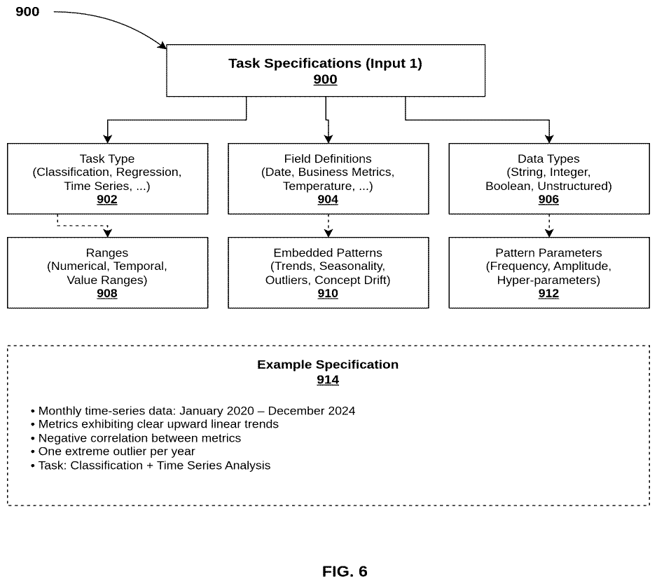

FIG. 6 illustrates a task specification diagram (900) showing the various task specification parameters that can be provided as input to the evaluation system. According to some embodiments, task specifications (input 1) define the configuration for synthetic data generation. The task specification branches into six parameter categories. According to one embodiment, a task type parameter (902) specifies the machine learning task such as classification, regression, or time series analysis. According to another embodiment, a field definitions parameter (904) specifies expected data fields such as dates, business metrics, and temperature. According to various embodiments, a data types parameter (906) specifies data types including string, integer, boolean, and unstructured types. According to some embodiments, a ranges parameter (908) defines numerical, temporal, and value ranges. According to one embodiment, an embedded patterns parameter (910) specifies hidden patterns to plant such as trends, seasonality, outliers, and concept drift. According to another embodiment, pattern parameters (912) define the hyper-parameters of the embedded patterns including frequency and amplitude. According to one example, an example specification (914) demonstrates monthly time-series data from January 2020 to December 2024, with metrics exhibiting clear upward linear trends, negative correlation between metrics, one extreme outlier per year, and classification plus time series analysis tasks.

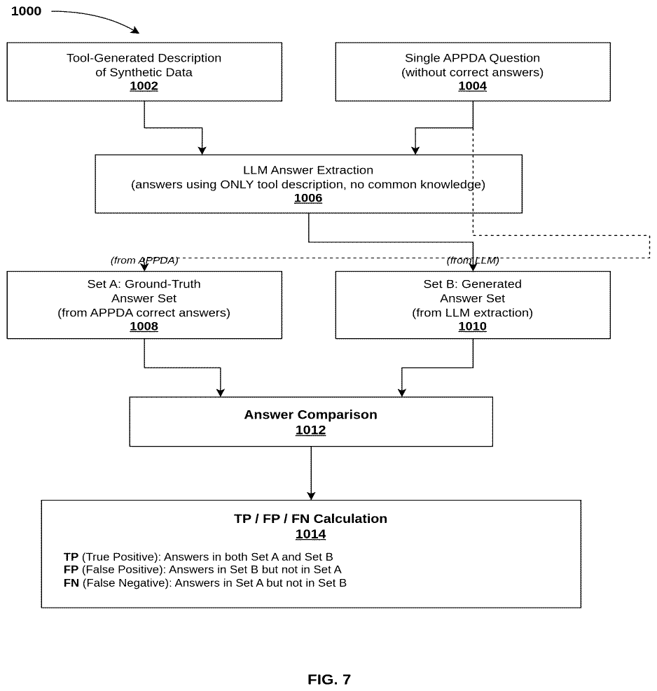

FIG. 7 illustrates the examination matching process (1000). According to some embodiments, the process receives two inputs: the tool-generated description of synthetic data (203) as the tool description input (1002) and a single APPDA question (1004) presented without correct answers. According to one embodiment, both inputs are provided to the LLM answer extraction (1006), which generates answers using only the tool description and no common knowledge or background information. According to various embodiments, the process produces two sets for comparison: a ground-truth answer set (1008) (Set A) derived from the APPDA correct answers, and a generated answer set (1010) (Set B) derived from the LLM extraction. According to another embodiment, both sets feed into answer comparison (1012), which systematically matches answers between the two sets. According to some embodiments, the answer comparison produces the TP FP FN calculation (1014), where true positives (TP) represent answers found in both Set A and Set B, false positives (FP) represent answers in Set B but not in Set A, and false negatives (FN) represent answers in Set A but not in Set B.

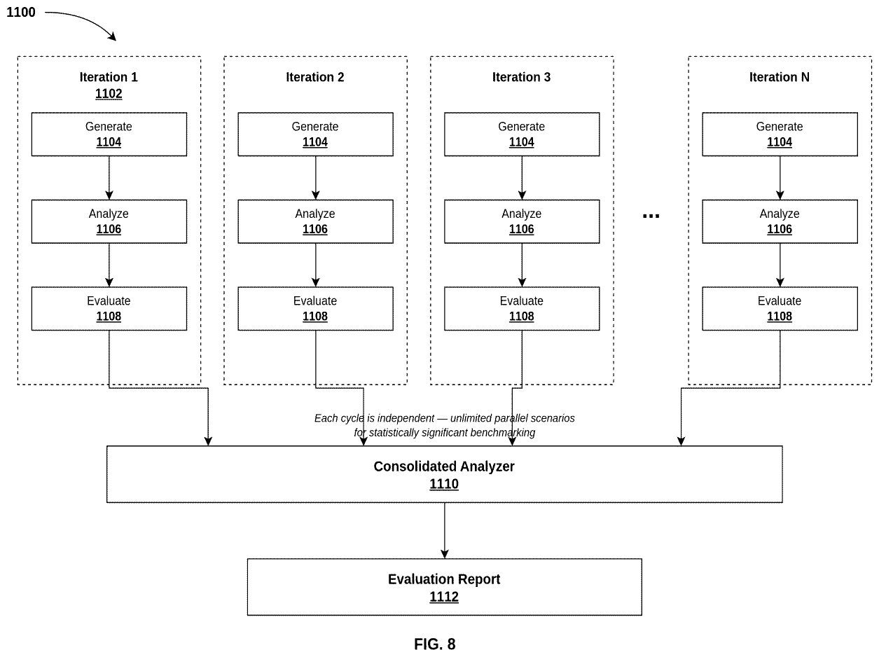

FIG. 8 illustrates the parallel execution architecture (1100) for scalable benchmarking. According to some embodiments, the architecture includes multiple independent iteration lanes (1102), each executing a complete generate-analyze-evaluate cycle in parallel. According to one embodiment, each iteration lane (1102) includes a generate step (1104) for producing synthetic data, an analyze step (1106) for running the candidate tool on the synthetic data, and an evaluate step (1108) for examining the tool's output against ground-truth assertions. According to various embodiments, because every cycle is independent, an unlimited number of scenarios can run in parallel to deliver statistically significant benchmarking in reasonable wall-clock time. According to another embodiment, all iteration results feed into a consolidated analyzer (1110), which aggregates the evaluation data across all iterations. According to some embodiments, the consolidated analyzer (1110) produces an evaluation report (1112) containing calculated metrics for the evaluated tool.

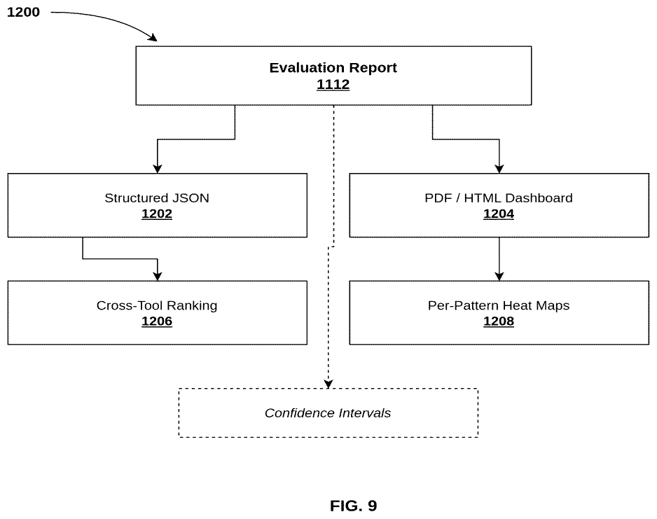

FIG. 9 illustrates the evaluation report outputs (1200) showing the various output formats of the evaluation report (1112). According to some embodiments, the evaluation report (1112) can produce multiple output formats. According to one embodiment, a structured JSON output (1202) provides machine-readable evaluation data. According to another embodiment, a PDF HTML dashboard (1204) provides a human-readable visualization of the evaluation results. According to various embodiments, the structured JSON output (1202) can be used to generate a cross-tool ranking (1206) for comparing multiple candidate tools. According to some embodiments, the PDF HTML dashboard (1204) can include per-pattern heat maps (1208) showing performance across different pattern types. According to one example, the evaluation report can also include confidence intervals derived from the statistical analysis of multiple evaluation iterations.

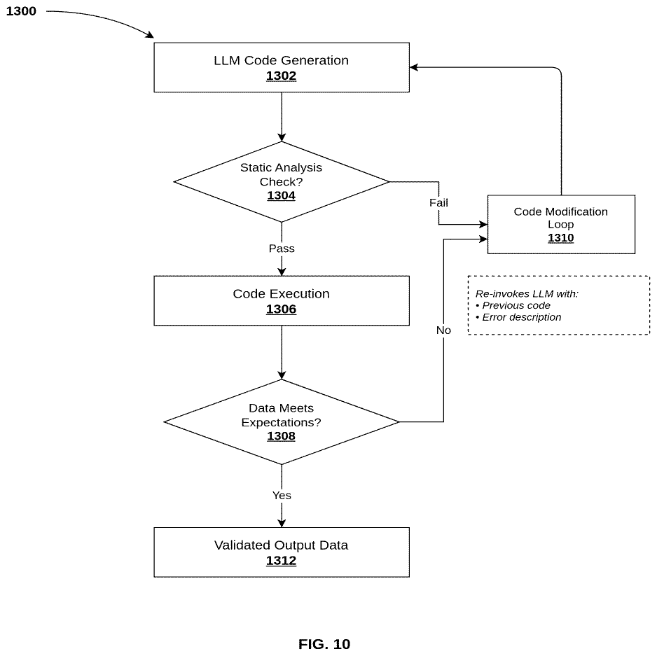

FIG. 10 illustrates the code modification mechanism (1300) used during synthetic data generation. According to some embodiments, the process begins with LLM code generation (1302), where the LLM produces code to generate synthetic data. According to one embodiment, the generated code is subjected to a static analysis check (1304) to detect potential security vulnerabilities or inconsistencies before execution. According to another embodiment, if the static analysis check (1304) fails, the process triggers a code modification loop (1310), which re-invokes the LLM with the previously generated code and a description of the error encountered. According to various embodiments, if the static analysis check (1304) passes, the code proceeds to code execution step (1306). According to some embodiments, after code execution, a data characteristics comparison (1308) evaluates whether the generated data meets expectations by comparing high-level characteristics such as dataset size, expected fields, and structural alignment with the original planning. According to one example, if the data fails to meet expectations, the code modification loop (1310) is triggered again to revise the code. According to another embodiment, if the data meets expectations, the process produces validated output data (1312) ready for use as synthetic data in the evaluation framework.

According to some embodiments, the system can be configured to accept a query input, analyze the input, and determine an atomic task associated with the input. The system can then use the atomic task to match two or more evaluated contexts for respective models. By hosting information on performance associated with atomic level information, the system is uniquely configured to match a query to a specific atomic context and identify a model or version that is best suited to providing a response to an associated query. According to one example, this means providing a finer tuned evaluation of accuracy, and/or targeting, and/or suitability for the respective query when compared to known solutions.

According to various embodiments, the system can host an interface for accepting free-form queries and in the background identify underlying tasks that are associated with the query, matching those tasks to evaluation metrics performed on respective models, and automatically select a model that provides the best level of accuracy, targeting, and suitability, among other options. According to another embodiment, the system can identify the model evaluated to be the best suited (e.g., most accurate, most targeted, or most suited, or any combination thereof, among other options). The system can then display the highest ranked model for selection in the user interface to respond to the query. According to some examples, the system can include a listing of ranked options for respective models that a user can select and then execute the query against or using.

According to one embodiment, although there are conventional solutions that attempt to rate models based on accuracy, targeting, suitability, and/or performance, these conventional solutions fail to provide the ranking on atomic level tasks. The rankings themselves can be muddled and the ratings based on improperly formed analysis that results in significant deviation from query performance when compared to testing performance. The system described herein addresses these deficiencies by providing atomic-level evaluation through APPDAs, enabling precise matching between query requirements and model capabilities.

According to some embodiments, the system can include a user interface configured to display ranked models for user selection. According to one embodiment, the user interface can present a list of candidate models ranked according to their evaluation metrics for the specific atomic tasks identified in the user's query. According to another embodiment, the user interface can display descriptions explaining why each model is best suited for the query entered into the UI. According to one example, the description can include specific APPDA-based metrics such as precision, recall, and F1 score for the relevant atomic tasks, enabling users to make informed decisions about model selection. Other embodiments can use any one or combination of the APPDA based metrics.

According to various embodiments, the user interface can include one or more of the following features: a query input field for accepting free-form queries from users; a ranked list of models displayed in order of suitability for the entered query; expandable detail sections showing evaluation metrics for each ranked model; visual indicators such as confidence scores or performance badges; comparison views allowing side-by-side evaluation of multiple models; and selection controls enabling users to choose a model and execute the query. According to some examples, the user interface can automatically highlight the top-ranked model while still providing access to alternative options.

According to one embodiment, the system can generate natural language explanations for model rankings based on the underlying APPDA evaluation data. According to another embodiment, these explanations can identify specific strengths and weaknesses of each model relative to the atomic tasks identified in the query. According to one example, an explanation can state that a particular model achieved high precision on trend detection tasks but lower recall on outlier identification, enabling users to understand the trade-offs involved in model selection. According to various embodiments, the explanations can be customized based on user expertise level, providing technical details for advanced users or simplified summaries for general users.

Returning to FIG. 1, the system and/or inputs can include one or more or any combination of the following.
Evaluation Data (401): This data includes the APPDAs and their corresponding TP, FP, and FN quantities.
Termination Condition Met? (500): This condition step decides whether to (1) repeat the process of synthetic data generation to generate another synthetic data and examine it, or (3) terminate the data generation process and perform analysis on Evaluation Data (401).
Analyzer of Evaluation Data (600): This module calculates evaluation metrics based on Evaluation Data (401). In Table I below, introduced are example metrics to calculate based on TP, FP, and FN. Note that any other task-agnostic or task-specific can be defined using Evaluation Data (401) and the metrics are just examples of metrics to calculate.
Evaluation Report (601): This is the output of Analyzer of Evaluation Data (600) which includes a set of metric values that evaluates Knowledge Discovery and Data Mining Tool (Input 2).

TABLE I

| Metric | Description | Definition | Interoperation |
|---|---|---|---|
| Jaccard | Jaccard = TP/ | Measures the overlap | High Score (close to 1): Indicates |
| Similarity | (TP + FP + FN) | between the Knowledge | that the tools' answer set closely |
| Index | | Discovery and Data | matches the correct set. |
| | | Mining Tool (Input | Low Score (close to 0): Indicates |
| | | 2)'s answers and the | significant discrepancies-either |
| | | correct ground- truth | by selecting many incorrect |
| | | answers. | answers (high FP) or by missing |
| | | | many correct answers (high FN). |
| Precision | Precision = TP/ | Measures the | High Precision (close to 1): |
| | (TP + FP) | proportion of the | Indicates that when a tool produces |
| | | answers provided by | an answer, it is very likely to be |
| | | the Knowledge | correct. |
| | | Discovery and Data | Low Precision (close to 0): |
| | | Mining Tool (Input 2) | Suggests the tool is selecting many |
| | | that are actually correct. | answers that are incorrect. |
| Recall | Recall = TP/ | Measures the | High Recall (close to 1): Indicates |
| | (TP + FN) | proportion of all the | the tool is covering most or all of |
| | | correct answers that | the correct answers. |
| | | the Knowledge | Low Recall (close to 0): Indicates |
| | | Discovery and Data | the tool missed many correct |
| | | Mining Tool (Input 2) | answers. |
| | | managed to produce. | |
| F1 Score | F1 = (2 *TP) / (2 | The harmonic mean of | High F1 Score (close to 1): |
| | TP + FP + FN) | precision and recall, | Indicates that the tool has both |
| | | which provides a | high precision and high recall. |
| | | single metric that | Low F1 Score (close to 0): |
| | | balances the trade-off | Reflects a deficiency in either |
| | | between the two. | precision, recall, or both. |
| Weighted | L = α × FP + B × FN, | Defined as 1 minus the | High Score (close to 1): Indicates |
| Loss- | where α and β are | normalized weighted | minimal loss, meaning few extra |
| Based | penalty weights for | sum of FPs and FNs, | answers (FP) and few missed |
| Score | FP and FN, | using penalty weights | correct answers (FN). |
| | respectively. | to balance their impact. | Low Score (close to 0): Indicates a |
| | Then, normalize | | high loss, meaning the tool |
| | the loss to | | produces many incorrect answers |
| | produce a score: | | or missed many correct ones. |
| | Score = 1 − (L/ | | Customization: By adjusting α and |
| | L_{max}) | | β, you can control whether FP or |
| | | | FN should be penalized more |
| | | | heavily, which allows for |
| | | | flexibility depending on the task's |
| | | | goals. |

### Example Considerations and Implementation

According to one embodiment, the system is customizable and the end user can specify their specific requirements and constraints in task specifications (e.g., Input 1). The system is flexible in the depth and the type of the patterns that it embeds and plants in any synthetic data (e.g., 202). It does not need to be tailored toward any specific task in its design. The system is task-agnostic, meaning that it does not assume any goal or machine learning task for tool-generated description of synthetic data (e.g., 203). The system does not have any assumptions on the depth and type of the analysis that a tool-generated description of synthetic data (e.g., 203) can perform. It also does not have any assumption about the language, tone, and style of the analysis that this tool generates. It also does not have assumptions about the type of the data that the tool accepts as input. The input data of this tool can be tabular, textual, visual, etc. The system compares tool-generated description of synthetic data (e.g., 203) and ground-truth description of synthetic data (e.g., 201) by defining atomic probing, profiling, and diagnostic assertions (e.g., APPDAs) (e.g., 301) to make the comparison robust and subjective, instead of simplifying the problem as text comparisons and pattern matchings. The system evaluates tool-generated description of synthetic data (e.g., 203) in terms of both correctness and completeness of its output by calculating TP, FP, and FN quantities. In further embodiments, a computer implemented method is provided that is customizable to define additional metrics based on TP, FP, and FN quantities. The system is highly-scalable since the close loop is controlled by Termination Condition Met? (500) defines stand-alone iterations that can be executed in parallel.

The system is LLM-agnostic and can work by any local or remote (on cloud) LLM model.

Other embodiments provide a fully-automated, LLM-centric evaluation framework for black-box knowledge-discovery and data-mining tools. Closed-loop “synthetic-reality” test bed: The system is configured to create an entire dataset on demand (of-the-fly) which includes hidden planted patterns whose ground-truth is known with mathematical certainty as a text description. It uses this deterministic ground-truth as a disposable laboratory in which to probe any candidate tool. Atomic Probing, Profiling & Diagnostic Assertions (APPDAs): Instead of blunt, subjective comparisons of two free-form narratives (as two texts), our proposed system decomposes the ground-truth into a number of atomic questions whose answers are deterministic but may have multiple valid phrasings. By scoring each APPDA individually (true positive (TP), false positive (FP), and false negative (FN)), the framework exposes where and why a tool succeeds or fails. Metric-agnostic analytics layer: From the TP, FP, FN quantities, our system calculate standard metrics (Precision, Recall, Jaccard, F-score) or any custom weighted loss the user defines which allows domain-specific penalties (e.g., “missing a safety hazard costs 5×flagging a benign outlier”). Task-, data- and LLM-agnostic: Whether the target tool ingests tabular time-series, customer reviews as textual data, or still images, the generator can craft matching synthetic data and embed domain-appropriate patterns; the examiner can use any local or cloud LLM to judge answers; and nothing in the pipeline presumes a particular task, tool, or model internals. Horizontally scalable Monte-Carlo harness: Because every “generate→analyze→evaluate” cycle is independent, an unlimited number of scenarios can run in parallel to deliver statistically significant benchmarking in reasonable wall-clock time.

Various embodiments of the system include any one or more or any combination of the following:

### Task Specification Intake:

Captures task type, field schema, ranges, and user-desired hidden patterns (e.g., trends, seasonality, drift, anomalies, etc.). Seasonality includes predictable, recurring patterns or fluctuations that occur at regular intervals due to seasonal factors such as weather, holidays, or events.

### Scenario Planner (e.g., 100)

Converts task specifications into an explicit, ordered Plan to Generate Synthetic Data, including tooling hints (e.g., e.g., “write Python+NumPy to generate ARIMA-like series”).

### Synthetic Data Generator (e.g., 200)

Executes the plan. It can generate the data by either of these approaches:
   a. One-shot ask an LLM or any other model for CSV/JSON, textual, visual data
   b. Generate code and then execute it, where the output of the code is the target data
Emits both Synthetic Data (e.g., 202) and Ground-Truth Description (e.g., 201) listing every planted pattern with parameter values.

### Black-Box Tool Invocation

Streams Synthetic Data (e.g., 202) into the candidate knowledge-discovery engine; captures its Tool-Generated Description (e.g., 203). No assumptions on the tool's internal components, functionalities, or external interfaces beyond “Receive input data, Generate output textual analysis.”

### APPDA Generator (e.g., 300)

Another LLM converts 201 into a set of atomic assertions (e.g., 301). These assertions are atomic, objective, and have deterministic answers.
Each assertion: single fact+list of acceptable answer strings, for example:
   Question: “What periodicity exists in the sales_volume field?”
   Answer: (“monthly”, “30-day” 1).

### APPDA Examiner (e.g., 400)

For each assertion, the examiner asks an LLM or any other model only using 203 as input context. It then string-/semantic-matches prediction vs. ground-truth answer set to calculate the TP, FP, and FN quantities and stores them into Evaluation Data (e.g., 401).

### Termination Controller (e.g., 500)

Policy to determine if another dataset should be created (e.g., e.g., “until N scenarios” or “until std-error<ε”).

### Analyzer (e.g., 600)

Calculate metrics based on the TP, FP, and FN quantities

### Evaluation Report (e.g., 601)

Generate the final evaluation
   report, for example:
   Structured JSON
   Human-readable PDF/HTML dashboard
   a Cross-tool ranking
   Per-pattern heat maps
   Confidence intervals

### Numbered Embodiments

1. A system for evaluating, validating, and benchmarking any knowledge discovery and data-mining tool, the system comprising: an optional part that takes in task specifications defining a target task, data types, fields, numerical ranges, and hidden patterns to be included in synthetic data; a planner that creates a clear, step-by-step plan for making synthetic data based on those instructions: a generator that produces synthetic data along with a text description that explains the hidden patterns embedded and planted in the data; interface that sends the synthetic data to a knowledge discovery and data-mining tool and receives a text description of any patterns that the tool finds; module that creates a set of atomic, targeted, and focused questions (called atomic Probing, Profiling, and Diagnostic assertions (APPDAs)) about specific details found in the ground-truth description of the synthetic data; an examiner (comparator) that checks the tool's description against the ground-truth by matching the answers to these atomic, targeted, and focused questions and counts how many answers are correct (TP), extra (FP), or missing (FN); analyzer that calculates evaluation metrics (such as the Jaccard Similarity Index, Precision, Recall, F1 Score, and a weighted score) based on those TP, FP, and FN quantities.
2. The system of any embodiment, in which the instructions include parameters for tasks such as classification, regression, time series analysis, data types to include in the synthetic data, or working with unstructured data. 3. The system of any embodiment, in which the generator can create synthetic data in various formats, including structured (e.g., tabular data) and unstructured data (e.g., textual or visual data). 4. The system of any embodiment, in which the planner creates the step-by-step plan by summarizing the input task specifications, noting any potential issues in data creation, point out necessary tools, and providing clear guidelines for inserting hidden patterns such as trends, seasonal changes, anomalies, unusual values, or shifts in data. 5. The system of any embodiment, in which the set of objective questions (atomic assertions) with deterministic answer(s) is generated to ask about one specific detail or piece of information of the ground-truth description at a time. 6. The system of any embodiment, in which the comparator counts, for each atomic, targeted, and focused question (atomic assertion), the number of correct answers found in both the tool's and the ground-truth descriptions (true positives), the number of extra answers found only in the tool's description (false positives), and the number of missing answers compared to the ground truth (false negatives). 7. The system of any embodiment, in which the analyzer calculates evaluation metrics including but not limited to: (a) Jaccard Similarity Index as TP divided by (TP+FP+FN); (b) Precision as TP divided by (TP+FP); (c) Recall as TP divided by (TP+FN); or (d) the F1 Score as (2×TP) divided by (2×TP+FP+FN). 8. The system of any embodiment, in which the analyzer also calculates a weighted score by giving different penalties to extra answers (false positives) and missing answers (false negatives). 9. The system of any embodiment, further comprising a control part that decides whether to repeat the cycle of synthetic data generation, analysis, and evaluation, or to stop once a certain condition is met. 10. The system of any embodiment, in which the data mining and knowledge discovery tool can be based on one or more language models or similar frameworks, and the system works independently of the tool's internal design.
11. A system for evaluating a candidate tool, the system comprising: at least one processor operatively connected to a memory, the at least one processor when executing configured to: accept specification of a target task the candidate tool is configured to perform, data types on which the candidate tool operates, data fields on which the candidate tool operates, including data field ranges (e.g., numerical ranges, value ranges, etc.), or hidden patterns to be included in synthetic data; (optional) generate a step-by-step plan for making synthetic data based on a defined specification; produce synthetic data in conjunction with respective text descriptions that explain the hidden patterns integrated into synthetic data; provide an interface (e.g., layer, agent, display, etc.) configured provide the synthetic data to the candidate tool (e.g., knowledge discovery and data-mining AI tool) and capture or accept a text description generated by the candidate tool including any patterns that tool finds in the synthetic data; evaluate the text description and the patterns found in the synthetic data by the candidate tool against details specified in a ground-truth definition used to produce synthetic data; and permit subsequent use of the candidate tool based, at least in part, on the evaluation of the text description and the patterns found. 12. The system of any embodiment, wherein the at least one processor is configured to evaluate the text description and the patterns produced by the candidate tool (e.g., found) based on atomic assertions (e.g., APPDAs) constructed on the ground-truth definitions. 13. The system of any embodiment, wherein the at least one processor is configured to: evaluate the description generated by the candidate tool against the ground-truth by matching respective descriptions; and generate counts how many answers are correct (TP), extra (FP), or missing (FN). 14. The system of any embodiment, wherein the at least one processor is configured to: calculate a plurality of evaluation metrics (e.g., Jaccard Similarity Index, Precision, Recall, F1 Score, and a weighted score) based on the generated counts on TP, FP, and FN quantities. 15. The system of any embodiment, wherein the at least one processor is configured to generate a step-by-step plan for making synthetic data based on a defined specification. 16. The system of any embodiment, wherein the at least one processor is configured to produce synthetic data in structured and unstructured formats. 17. The system of any embodiment, wherein the at least one processor is configured to generate atomic probing, profiling, & diagnostic assertions (APPDAs) that each focus on an atomic piece of information from the ground-truth description. 18. The system of any embodiment, wherein the at least one processor is configured to determine, for a plurality of APPDAs, a number of correct answers, extra answers, and missing answers in the tool-generated description as compared to the ground-truth description. 19. The system of any embodiment, wherein the at least one processor is configured to calculate evaluation metrics including a Jaccard Similarity Index, Precision, Recall, and F1 Score based on the counted correct answers, extra answers, and missing answers. 20. The system of any embodiment, wherein the at least one processor is configured to calculate a weighted score by assigning different penalties to extra answers and missing answers. 21. The system of any embodiment, wherein the at least one processor is configured to determine whether to repeat a cycle of synthetic data generation, analysis, and evaluation (e.g., based on a termination condition). 22. The system of any embodiment, wherein the at least one processor is configured to prevent subsequent use of the candidate tool based, at least in part, on the evaluation of the text description and the patterns found. 23. The system of any embodiment, wherein the at least one processor is configured to label or associate the candidate tool with a status associated with the evaluation and permit or prevent subsequent use based on the status.
24. A method for evaluating a candidate tool, the method comprising: accepting, by at least one processor, specification of a target task the candidate tool is configured to perform, data types on which the candidate tool operates, data fields on which the candidate tool operates, including data field ranges, or hidden patterns to be included in synthetic data; generating, by the at least one processor, a step-by-step plan for making synthetic data based on a defined specification; producing, by the at least one processor, synthetic data in conjunction with respective text descriptions that explain the hidden patterns integrated into synthetic data; providing, by the at least one processor, an interface configured to provide the synthetic data to the candidate tool and capture or accept a text description generated by the candidate tool including any patterns that tool finds in the synthetic data; evaluating, by the at least one processor, the text description and the patterns found in the synthetic data by the candidate tool against details specified in a ground-truth definition used to produce synthetic data; and permitting, by the at least one processor, subsequent use of the candidate tool based, at least in part, on the evaluation of the text description and the patterns found. 25. The method of any embodiment, further comprising evaluating, by the at least one processor, the text description and the patterns produced by the candidate tool based on atomic assertions constructed on the ground-truth definitions. 26. The method of any embodiment, further comprising: evaluating, by the at least one processor, the description generated by the candidate tool against the ground-truth by matching respective descriptions; and generating, by the at least one processor, counts of how many answers are correct (TP), extra (FP), or missing (FN). 27. The method of any embodiment, further comprising: calculating, by the at least one processor, a plurality of evaluation metrics based on the generated counts on TP, FP, and FN quantities. 28. The method of any embodiment, wherein producing synthetic data comprises producing synthetic data in structured and unstructured formats. 29. The method of any embodiment, further comprising generating, by the at least one processor, atomic probing, profiling, and diagnostic assertions (APPDAs) that each focus on an atomic piece of information from the ground-truth description. 30. The method of any embodiment, further comprising determining, by the at least one processor, for a plurality of APPDAs, a number of correct answers, extra answers, and missing answers in the tool-generated description as compared to the ground-truth description. 31. The method of any embodiment, further comprising calculating, by the at least one processor, evaluation metrics including a Jaccard Similarity Index, Precision, Recall, and F1 Score based on the counted correct answers, extra answers, and missing answers. 32. The method of any embodiment, further comprising calculating, by the at least one processor, a weighted score by assigning different penalties to extra answers and missing answers. 33. The method of any embodiment, further comprising determining, by the at least one processor, whether to repeat a cycle of synthetic data generation, analysis, and evaluation. 34. The method of any embodiment, further comprising preventing, by the at least one processor, subsequent use of the candidate tool based, at least in part, on the evaluation of the text description and the patterns found. 35. The method of any embodiment, further comprising labeling or associating, by the at least one processor, the candidate tool with a status associated with the evaluation and permitting or preventing subsequent use based on the status.
36. A non-transitory computer-readable medium storing instructions that, when executed by at least one processor, cause the at least one processor to: accept specification of a target task a candidate tool is configured to perform, data types on which the candidate tool operates, data fields on which the candidate tool operates, including data field ranges, or hidden patterns to be included in synthetic data; generate a step-by-step plan for making synthetic data based on a defined specification; produce synthetic data in conjunction with respective text descriptions that explain the hidden patterns integrated into synthetic data; provide an interface configured to provide the synthetic data to the candidate tool and capture or accept a text description generated by the candidate tool including any patterns that tool finds in the synthetic data; evaluate the text description and the patterns found in the synthetic data by the candidate tool against details specified in a ground-truth definition used to produce synthetic data; and permit subsequent use of the candidate tool based, at least in part, on the evaluation of the text description and the patterns found. 37. The non-transitory computer-readable medium of any embodiment, wherein the instructions further cause the at least one processor to evaluate the text description and the patterns produced by the candidate tool based on atomic probing, profiling, and diagnostic assertions (APPDAs) constructed on the ground-truth definitions. 38. The non-transitory computer-readable medium (“CRM”) of any embodiment, wherein the instructions further cause the at least one processor to: evaluate the description generated by the candidate tool against the ground-truth by matching respective descriptions; and generate counts of how many answers are correct (TP), extra (FP), or missing (FN). 39. The non-transitory CRM of any embodiment, wherein the instructions further cause the at least one processor to calculate a plurality of evaluation metrics including a Jaccard Similarity Index, Precision, Recall, and F1 Score based on the generated counts on TP, FP, and FN quantities. 40. The non-transitory CRM of any embodiment, wherein the instructions further cause the at least one processor to: generate atomic probing, profiling, and diagnostic assertions (APPDAs) that each focus on an atomic piece of information from the ground-truth description; determine, for a plurality of APPDAs, a number of correct answers, extra answers, and missing answers in the tool-generated description as compared to the ground-truth description; and determine whether to repeat a cycle of synthetic data generation, analysis, and evaluation based on a termination condition. 41. The system of any embodiment, wherein the at least one processor is configured to execute a plurality of evaluation cycles in parallel, each evaluation cycle comprising generating synthetic data, analyzing the synthetic data with the candidate tool, and evaluating the candidate tool's output against ground-truth assertions. 42. The system of any embodiment, wherein the at least one processor is configured to produce the synthetic data via one of: a one-shot generation pathway in which a large language model directly produces output data, or a code generation pathway in which a large language model generates executable code that is executed to produce the output data. 43. The system of any embodiment, wherein the at least one processor is configured to: generate code to produce the synthetic data; perform a static analysis check on the generated code to detect potential security vulnerabilities or inconsistencies before execution; execute the code upon passing the static analysis check; and trigger a code modification loop to re-invoke a large language model with the previously generated code and a description of an error encountered when the code fails the static analysis check. 44. The system of any embodiment, wherein the at least one processor is configured to generate an evaluation report in at least one of: a structured JSON format, a PDF format, an HTML dashboard format, a cross-tool ranking format, or a per-pattern heat map format. 45. The method of any embodiment, further comprising executing, by the at least one processor, a plurality of evaluation cycles in parallel, each evaluation cycle comprising generating synthetic data, analyzing the synthetic data with the candidate tool, and evaluating the candidate tool's output against ground-truth assertions. 46. The system of any embodiment, wherein the at least one processor is configured to: accept a query input: analyze the query input to determine an atomic task associated with the query input; match the atomic task to evaluated contexts for a plurality of candidate models based on atomic-level evaluation metrics; and identify a candidate model from the plurality of candidate models that is best suited to providing a response to the query input based on the matching. 47. The method of any embodiment, further comprising: accepting, by the at least one processor, a query input; analyzing, by the at least one processor, the query input to determine an atomic task associated with the query input; matching, by the at least one processor, the atomic task to evaluated contexts for a plurality of candidate models based on atomic-level evaluation metrics; and displaying, by the at least one processor, a ranked list of candidate models in a user interface, wherein the ranked list includes descriptions explaining why each candidate model is suited for the query input based on APPDA-based evaluation metrics. 48. The non-transitory CRM of any embodiment, wherein the instructions further cause the at least one processor to: accept a query input via a user interface; analyze the query input to determine an atomic task associated with the query input; match the atomic task to evaluated contexts for a plurality of candidate models based on atomic-level evaluation metrics; generate a ranked list of candidate models based on the matching; and display the ranked list in the user interface with natural language explanations identifying strengths and weaknesses of each candidate model relative to the atomic task.

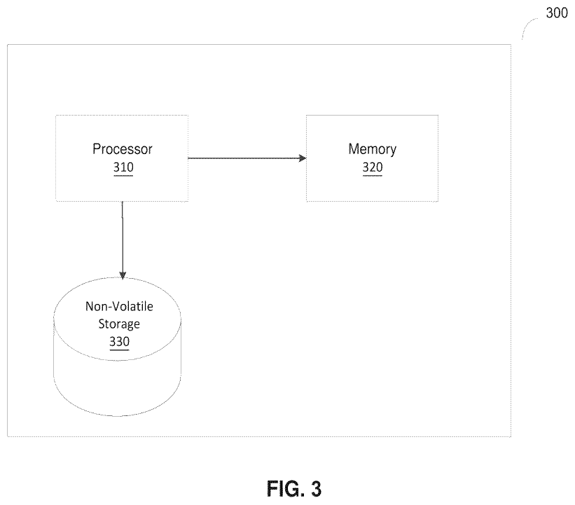

Additionally, an illustrative implementation of a special purpose computer system 300, that may be specially programmed to improve over conventional systems, to be used in connection with any of the embodiments of the disclosure provided herein is shown in FIG. 3. The computer system 300 may include one or more processors 310 and one or more articles of manufacture that comprise non-transitory computer-readable storage media (e.g., memory 320 and one or more non-volatile storage media 330). The processor 310 may control writing data to and reading data from the memory 320 and the non-volatile storage device 330 in any suitable manner. To perform any of the functionality described herein (e.g., secure execution, proxied execution, sandboxed execution, etc.), the processor 310 may execute one or more processor-executable instructions stored in one or more non-transitory computer-readable storage media (e.g., the memory 320), which may serve as non-transitory computer-readable storage media storing processor-executable instructions for execution by the processor 310.

The terms “program” or “software” or “app” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationships between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having the same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A system for evaluating a candidate tool, the system comprising:
at least one processor operatively connected to a memory, the at least one processor when executing, configured to:
accept specification of a target task the candidate tool is configured to perform, data types on which the candidate tool operates, data fields on which the candidate tool operates, including data field ranges, or hidden patterns to be included in synthetic data;
produce synthetic data in conjunction with respective text descriptions that explain the hidden patterns integrated into synthetic data;
provide an interface configured to provide the synthetic data to the candidate tool and capture or accept a text description generated by the candidate tool including any patterns that tool finds in the synthetic data;
evaluate the text description and the patterns found in the synthetic data by the candidate tool against details specified in a ground-truth definition used to produce synthetic data; and
permit subsequent use of the candidate tool based, at least in part, on the evaluation of the text description and the patterns found.

2. The system of claim 1, wherein the at least one processor is configured to evaluate the text description and the patterns produced by the candidate tool based on atomic assertions constructed on the ground-truth definitions.

3. The system of claim 1, wherein the at least one processor is configured to:
evaluate the description generated by the candidate tool against the ground-truth by matching respective descriptions; and
generate counts how many answers are correct (TP), extra (FP), or missing (FN).

4. The system of claim 3, wherein the at least one processor is configured to:
calculate a plurality of evaluation metrics based on the generated counts on TP, FP, and FN quantities.

5. The system of claim 1, wherein the at least one processor is configured to generate a step-by-step plan for making synthetic data based on a defined specification.

6. The system of claim 1, wherein the at least one processor is configured to produce synthetic data in structured and unstructured formats.

7. The system of claim 1, wherein the at least one processor is configured to generate atomic probing, profiling, & diagnostic assertions (APPDAs) that each focus on an atomic piece of information from the ground-truth description.

8. The system of claim 7, wherein the at least one processor is configured to determine, for a plurality of APPDAs, a number of correct answers, extra answers, and missing answers in the tool-generated description as compared to the ground-truth description.

9. The system of claim 8, wherein the at least one processor is configured to calculate evaluation metrics including a Jaccard Similarity Index, Precision, Recall, and F1 Score based on the counted correct answers, extra answers, and missing answers.

10. The system of claim 9, wherein the at least one processor is configured to calculate a weighted score by assigning different penalties to extra answers and missing answers.

11. The system of claim 1, wherein the at least one processor is configured to determine whether to repeat a cycle of synthetic data generation, analysis, and evaluation (e.g., based on a termination condition).

12. The system of claim 1, wherein the at least one processor is configured to prevent subsequent use of the candidate tool based, at least in part, on the evaluation of the text description and the patterns found.

13. The system of claim 1, wherein the at least one processor is configured to label or associate the candidate tool with a status associated with the evaluation and permit or prevent subsequent use based on the status.

14. A method for evaluating a candidate tool, the method comprising:
accepting, by at least one processor, specification of a target task the candidate tool is configured to perform, data types on which the candidate tool operates, data fields on which the candidate tool operates, including data field ranges, or hidden patterns to be included in synthetic data;
generating, by the at least one processor, a step-by-step plan for making synthetic data based on a defined specification;
producing, by the at least one processor, synthetic data in conjunction with respective text descriptions that explain the hidden patterns integrated into synthetic data;
providing, by the at least one processor, an interface configured to provide the synthetic data to the candidate tool and capture or accept a text description generated by the candidate tool including any patterns that tool finds in the synthetic data;
evaluating, by the at least one processor, the text description and the patterns found in the synthetic data by the candidate tool against details specified in a ground-truth definition used to produce synthetic data; and
permitting, by the at least one processor, subsequent use of the candidate tool based, at least in part, on the evaluation of the text description and the patterns found.

15. The method of claim 14, further comprising evaluating, by the at least one processor, the text description and the patterns produced by the candidate tool based on atomic assertions constructed on the ground-truth definitions.

16. The method of claim 14, further comprising:
evaluating, by the at least one processor, the description generated by the candidate tool against the ground-truth by matching respective descriptions; and
generating, by the at least one processor, counts of how many answers are correct (TP), extra (FP), or missing (FN).

17. The method of claim 16, further comprising:
calculating, by the at least one processor, a plurality of evaluation metrics based on the generated counts on TP, FP, and FN quantities.

18. The method of claim 14, wherein producing synthetic data comprises producing synthetic data in structured and unstructured formats.

19. The method of claim 14, further comprising generating, by the at least one processor, atomic probing, profiling, and diagnostic assertions (APPDAs) that each focus on an atomic piece of information from the ground-truth description.

20. The method of claim 19, further comprising determining, by the at least one processor, for a plurality of APPDAs, a number of correct answers, extra answers, and missing answers in the tool-generated description as compared to the ground-truth description.
